(19) United States
(12) Patent Application Publication
(10) Pub. No.: US 2022/0095851 A1
(43) Pub. Date: Mar. 31, 2022

(54) SOAP DISPENSER TIMER SYSTEM

(71) Applicants: Jessica Romanyszyn, Oakland, FL (US); Serge Romanyszyn, Oakland, FL (US)

(72) Inventors: Jessica Romanyszyn, Oakland, FL (US); Serge Romanyszyn, Oakland, FL (US)

(21) Appl. No.: 17/033,566

(22) Filed: Sep. 25, 2020

(51) Int. Cl. A47K 5/12; G08B 7/06; G08B 21/24; G08C 19/00

(52) U.S. Cl. CPC A47K 5/1217; G08C 19/00; G08B 21/245; G08B 7/06

(57) ABSTRACT

A soap dispenser timing system includes a main body having a liquid holding reservoir, a pump, a dispensing nozzle, an infrared sensor for detecting a user's hand, a speaker for playing audible sounds and a plurality of lights for displaying a visual indication. A controller includes a processor, memory and timer module for selectively activating each of the speaker and lights for twenty seconds upon receiving a signal from the sensor. The pump includes a manually activated pump mechanism that is linked to a pump arm or an electronic pump that automatically dispenses soap stored within the reservoir to a user's hand upon detection of the hand by the sensor.

### TECHNICAL FIELD

The present invention relates generally to cleaning and sanitizing devices, and more particularly to a soap dispenser timer system.

### BACKGROUND

The statements in this section merely provide background information related to the present disclosure and may not constitute prior art.

The COVID-19 pandemic of 2020 has ushered in a new era that requires everyone to do their part to prevent the spread of contagions. Aside from using personal protective equipment (PPE), such as facemasks, for example, individuals are encouraged to constantly wash and/or sanitize their hands.

To this end, there are a number of commercially available hand sanitizers that use a combination of chemicals to eliminate harmful contagions on contact. Although useful, such products have a tendency to leave a sticky residue on the skin, and some people can have allergic reactions to the sanitizer materials. As such, hand washing with soap and water for at least 20 seconds remains the number one doctor recommended practice to avoid the spread of contagions.

Unfortunately, many individuals do not wait the full 20 seconds before rinsing the soap off of their hands. As a result, the soap does not have enough time to thoroughly clean the user's skin, and there is a risk the user could spread harmful contagions.

Accordingly, it would be beneficial to provide a soap dispenser timer system that can function to provide an audiovisual notification to a user that they have satisfied the minimum necessary period before rinsing their hands.

### SUMMARY OF THE INVENTION

The present invention is directed to a soap dispenser timing system. One embodiment of the present invention can include a main body having a liquid holding reservoir, a pump, a dispensing nozzle, and a plurality of electronic components that function to provide an audiovisual notification to a user to lather their hands with soap for a predetermined period of time.

In one embodiment, the electronic components can include an infrared sensor for detecting a user's hand, a speaker for playing audible sounds and at least one light for displaying a visual indication. In one embodiment, the controller can include a timer module and can function to selectively activate each of the audiovisual components for twenty seconds.

In one embodiment, the pump can include a manually activated pump mechanism that is linked to a pump arm. In one embodiment, the pump can include an electronic pump that automatically dispenses soap stored within the reservoir to a user's hand upon detection of the hand by the sensor.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a side view of a soap dispenser timer system that is useful for understanding the inventive concepts disclosed herein.

FIG. 2 is a simplified block diagram of the internal controller of the soap dispenser timer system, in accordance with one embodiment of the invention.

FIG. 3 is a side view of the soap dispenser timer system, in accordance with one embodiment of the invention.

FIG. 4 is a perspective view of the soap dispenser timer system in operation, accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

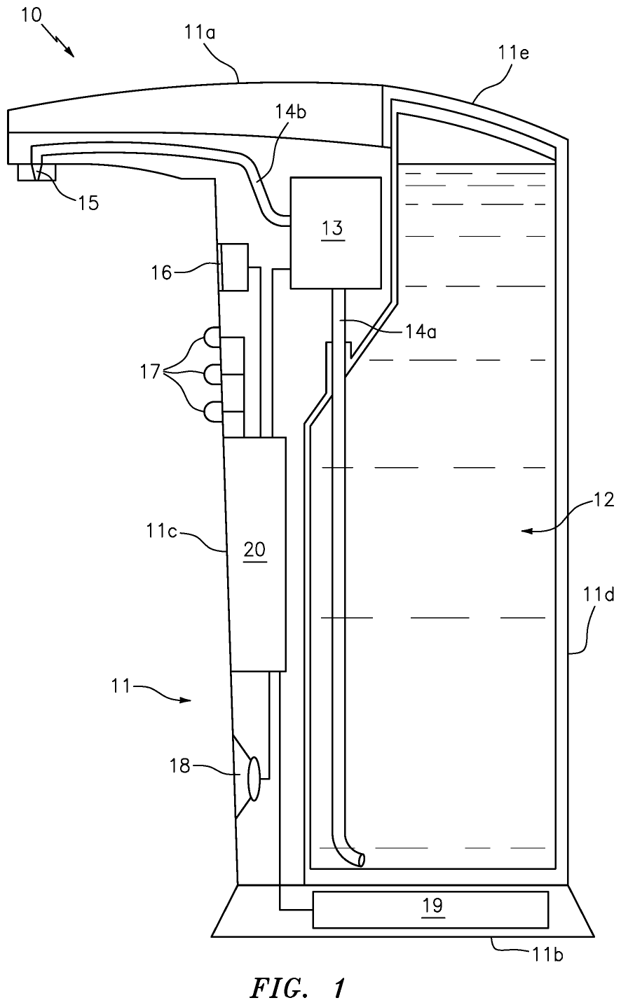

FIGS. 1-4 illustrate one embodiment of a soap dispenser timer system 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As shown in FIG. 1, one embodiment of the inventive soap dispenser system 10 can include a main body 11 having a top end 11a, a bottom end 11b a front side 11c, and a back side 11d. The main body can include any number of different shapes and sizes, and may be constructed from any number of different materials such as plastic or metal, for example. Although illustrated as a freestanding unit, other embodiments are contemplated wherein the main body includes wall mounting hardware for securement to a wall or other such structure. In such embodiments, the arrangement of components may be shifted so as to permit dispensing of the soap from the bottom of the main body.

In one embodiment, a liquid receptacle 12 can be positioned inside the main body at a location adjacent to the back side of the device. The receptacle can preferably be formed as a unitary element of the main body and can include an open top end that is selectively covered by a removable lid section 11e for receiving any type of liquid such as liquid soap, for example.

Although illustrated with regard to a particular location and function, other embodiments are contemplated wherein the receptacle is located at other locations along or within the main body and/or wherein the receptacle is formed as a separate component that is removably joined to the main body so as to be disposable in nature.

In one embodiment, a pump 13 can be positioned within the main body and can be connected to a suction pipe 14a and a discharge pipe 14b. In the present embodiment, the pump 13 can include, comprise or consist of any type of fluid dispensing pump that is in electrical communication with the below described controller 20 to selectively pull soap from the reservoir via the suction pipe and dispense the same through a nozzle 15 along the distal end of the discharge pipe 14b.

In one embodiment, a sensor 16 can be positioned along the main body so as to detect a user's hand when it is within a predetermined distance from the nozzle 15. In the preferred embodiment, the sensor 16 can include an infrared motion sensor, and the predetermined distance can be between 1 and 5 inches, for example. Of course, any number of other sensors capable of detecting motion and/or the presence of a foreign object at any number of other distances are also contemplated.

In one embodiment, one or more lights 17 can be disposed along the main body. Each of the one or more lights can preferably include a light emitting diode (LED), for example, that can produce light in any number of different colors, and patterns (e.g., flash, or remain illuminated), based on an instruction from the controller.

In one embodiment, a speaker 18 can be positioned along the main body and can function to play any number of sounds as directed by the controller.

In one embodiment, a power source 19 can include one or more DC batteries capable of providing the necessary power requirements to each element of the system 10. In one embodiment, the batteries can be permanently located within the main body and can be accessible via a removable cover (not illustrated) for allowing a user to access the same. Of course, other embodiments are contemplated wherein the power source includes or is connected to a common A/C electrical power transformer and cord capable of allowing the system 10 to be powered from a standard electrical outlet.

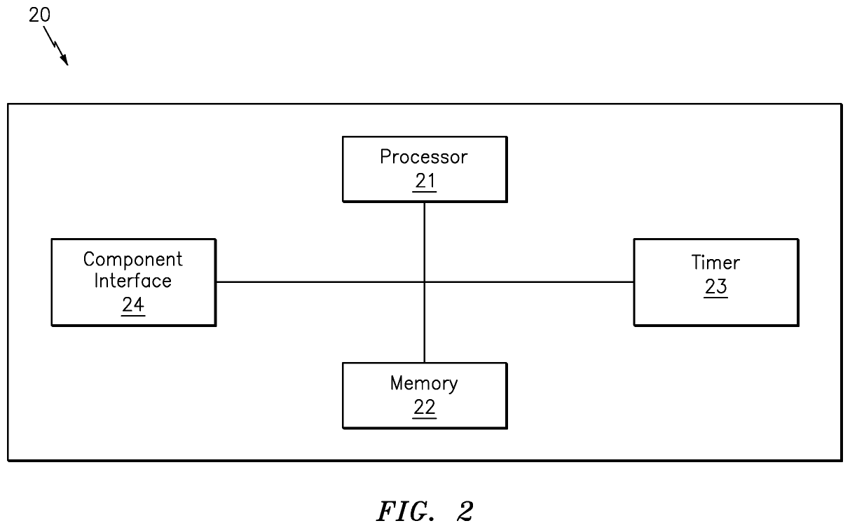

FIG. 2 illustrates one exemplary embodiment of the device controller 20 that includes a processor 21 that is conventionally connected to an internal memory 22, a timer module 23 and a component interface 24.

Although illustrated as separate elements, those of skill in the art will recognize that one or more system components may comprise or include one or more printed circuit boards (PCB) containing any number of integrated circuit or circuits for completing the activities described herein. Of course, any number of other analog and/or digital components capable of performing the below described functionality can be provided in place of, or in conjunction with the below described controller elements.

The processor 21 can be a conventional central processing unit (CPU) or any other type of device, or multiple devices, capable of manipulating or processing information such as program code stored in the memory 22 and for causing the circuitry to complete the activities and functionality described herein.

The timer module 23 can be provided, and can function to accurately measure the passage of time. As described herein, the timer module can be provided as a function of the processor or can include a separate physical circuit. In either instance, processors and timers are extremely well known in the art, therefore no further description will be provided.

Memory 22 can act to store operating instructions in the form of program code for the processor 21 to execute. Although illustrated in FIG. 2 as a single component, memory 22 can include one or more physical memory devices such as, for example, local memory and/or one or more bulk storage devices. To this end, the memory 22 can store operating instructions for allowing the system 10 to function in the manner herein described, and can also store content to be played by the speaker 18 such as a particular spoken phrase, sound or music, for example.

The component interface unit 24 can function to provide a communicative link between the processor 21 and various other device components such as the pump 13, sensor 16, lights 17, speaker 18, and power source 19, for example. In this regard, the component interface unit can include any number of different components such as one or more PIC microcontrollers, internal bus, USB connections and other such hardware capable of providing a direct link between the various components. Of course, any other means for providing the two-way communication between the identified components can also be utilized herein.

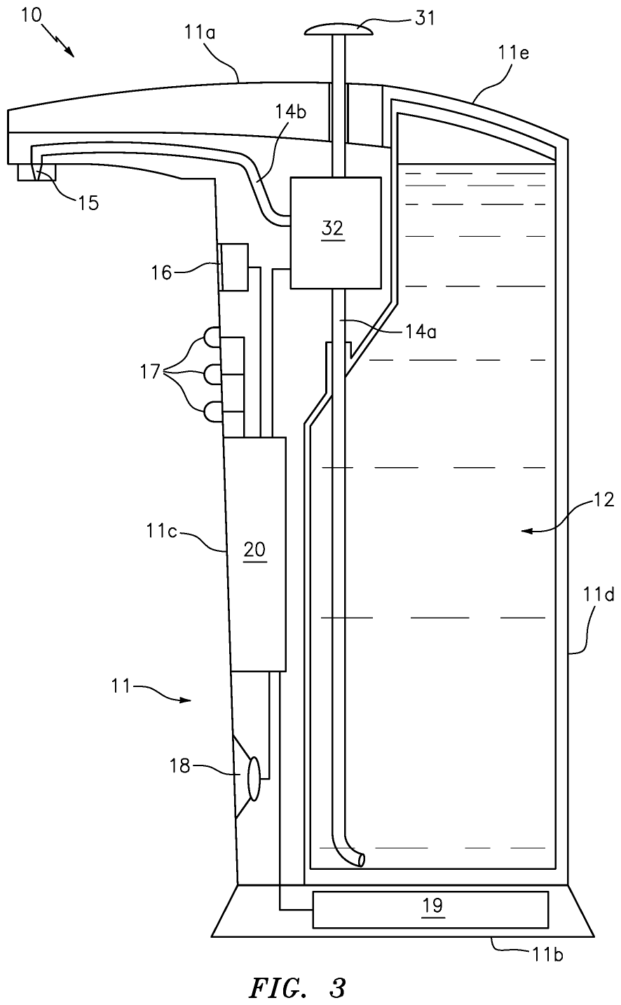

Although described above with regard to an electric pump, this is for illustrative purposes only. To this end, FIG. 3 illustrates one embodiment of the system 10 having a manual pump arm 31 that is connected to a pump mechanism 32 which typically has a spring mechanism and plunger such as those used in liquid dispensers well known in the art. To this end, the pump mechanism 32 may be any of many different types of manually operated pumps capable of forcing liquids out of the reservoir and through the nozzle 15.

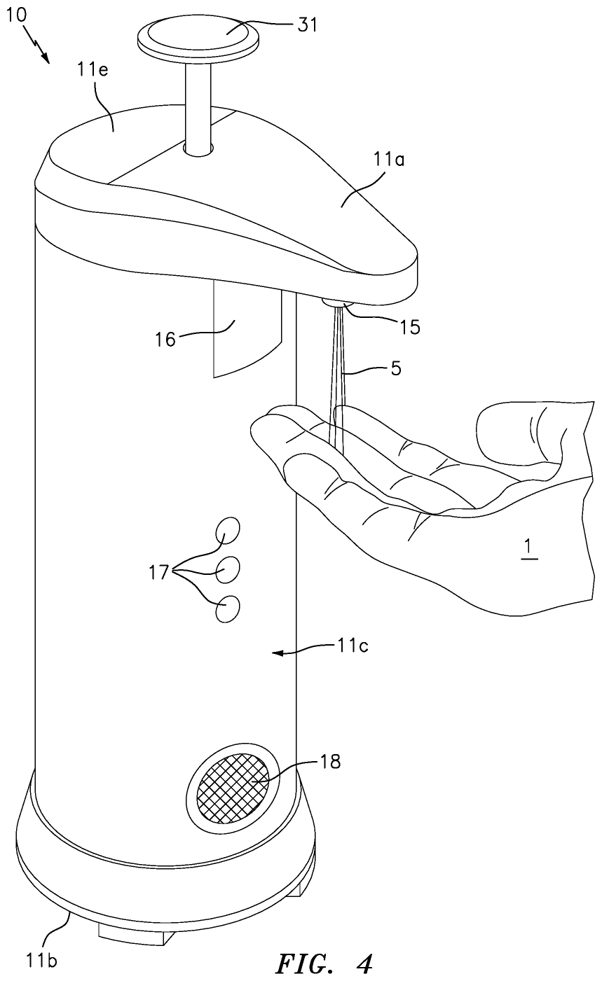

FIG. 4 illustrates one embodiment of the system 10 in operation. As shown, the sensor 16 can detect the presence of the user's hand 1, and soap 5 can be automatically dispensed by the pump or through manual activation of the arm 31. Next, the module can begin a pre-programmed countdown of 20 seconds. Of course, other embodiments are contemplated wherein different times are counted as set forth by the manufacturer and/or a custom time provided by the user.

In either instance, upon initiating the countdown, the lights 17 and/or speaker 18 can function to provide visual and/or audible notifications to the user throughout the countdown period. The notifications functioning to ensure and inform the user to continue lathering their hands with the dispensed soap before washing. In one embodiment, the lights 17 can flash red, and the speaker can say “keep lathering,” for example. Upon the expiration of the countdown, the lights and speaker can transition to an OFF setting, or can provide a second audiovisual cue such as the lights flashing green for three times, and/or the speaker saying “good job, time to rinse,” for example.

Accordingly, the above described system provides a novel and innovative means for ensuring users thoroughly lather and rinse their hands for a duration specified by the CDC or other governing body recommendations.

As described herein, one or more elements of the system 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A soap dispensing system, comprising:
a main body having a top end, a bottom end a front surface, and an interior space;
a liquid holding reservoir that is positioned within the interior space of the main body;
a nozzle that is in fluid communication with the liquid holding reservoir;
a pump that is disposed between the nozzle and the liquid holding reservoir;
a sensor that is positioned along the main body;
an audiovisual device that is positioned along the main body; and
a controller that is in communication with each of the sensor and the audiovisual device said controller including a timer module,
wherein the sensor is configured to detect an object within a set distance from the main body and to send a detection notification to the controller, and
wherein the controller is configured to immediately activate the audiovisual device for a predetermined period of time upon receiving the detection notification from the sensor, and to deactivate the audiovisual device upon a conclusion of the predetermined period of time.

2. (canceled)

3. The system of claim 1, wherein the audiovisual device comprises a speaker.

4. The system of claim 1, wherein the audiovisual device comprises a plurality of lights.

5. The system of claim 1, wherein the audiovisual device comprises a plurality of lights and a speaker.

6. The system of claim 1, wherein the predetermined period of time comprises 20 seconds.

7. The system of claim 1, wherein the sensor includes an infrared sensor.

8. The system of claim 7, wherein the set distance is between one inch and four inches.

9. The system of claim 1, wherein the pump comprises an electric pump that is communicatively linked to the controller.

10. The system of claim 9, wherein the controller is configured to selectively activate the electric pump to dispense a liquid stored within the liquid holding reservoir upon receiving the detection notification from the sensor.

11. The system of claim 1, further comprising:
a power source that is positioned within the main body.

12. The system of claim 11, wherein the power source comprises at least one battery.

13. The system of claim 1, wherein the pump comprises a manually activated pump.

14. The system of claim 1, wherein the liquid holding reservoir is removably connected to the main body.

15. A method, comprising:
providing a soap dispensing system that includes a main body having a top end, a bottom end a front surface, and an interior space, a liquid holding reservoir that is positioned within the interior space of the main body, a nozzle that is in fluid communication with the liquid holding reservoir, a pump that is disposed between the nozzle and the liquid holding reservoir, a sensor that is positioned along the main body, an audiovisual device that is positioned along the main body, and a controller having a timer module that is in communication with each of the sensor and the audiovisual device;
detecting, by the sensor, an object within a set distance from the main body;
sending, by the sensor, a detection notification to the controller;
activating, by the controller, the pump to dispense a liquid stored within the liquid holding reservoir upon receiving the detection notification;
activating, by the controller, the timer module for a predetermined period of time;
activating, by the controller, the audiovisual device;
detecting, by the controller, the predetermined period of time has concluded; and
deactivating, by the controller, the audiovisual device.
